(19) United States
(12) Patent Application Publication
(10) Pub. No.: US 2019/0223476 A1
(43) Pub. Date: Jul. 25, 2019

(54) UPCYCLING SOLID FOOD WASTES AND BY-PRODUCTS INTO HUMAN CONSUMPTION PRODUCTS

(71) Applicant: Usarium Inc., Palo Alto, CA (US)

(72) Inventors: Aleh Manchuliantsau, Vitebsk (BY); Anastasia Tkacheva, Zelenograd (RU)

(21) Appl. No.: 16/370,898

(22) Filed: Mar. 30, 2019

Related U.S. Application Data
(62) Division of application No. 16/285,223, filed on Feb. 26, 2019.
Application No. 16/285,223 is a continuation of application No. 15/965,992, filed on Apr. 30, 2018.
(60) Provisional application No. 62/736,741, filed on Sep. 26, 2018.
(60) Provisional application No. 62/713,251, filed on Aug. 1, 2018.
(60) Provisional application No. 62/492,367, filed on May 1, 2017.

(51) Int. Cl. A23L 5/20; A21D 13/80; A23L 33/105; A23L 7/135; A23L 23/00; A23J 1/00; A23L 19/00; A23L 7/109; A21D 13/44; A21D 13/42; A21D 17/00; A23P 30/20

(52) U.S. Cl. CPC A23L 5/21; A21D 13/80; A23L 33/105; A23L 7/135; A23L 23/00; A23J 1/005; A23V 2002/00; A23L 7/109; A21D 13/44; A21D 13/42; A21D 17/008; A23P 30/20; A23L 19/07

(57) ABSTRACT

Systems and methods for system for upcycling solid food wastes and by-products into food-grade nutritional products and the high-protein nutritional product manufactured by the systems and methods are described herein. A system for upcycling solid food wastes and by-products into food-grade nutritional products may include an extruder. The extruder may be configured to receive a raw plant-based material and continuously subject the raw plant-based material to steam flashing at predetermined temperature and predetermined pressure to sterilize the raw plant-based material, destroy antinutrients present in the raw plant-based material, cause a break up of larger cellular and subcellular units of the raw plant-based material into smaller cellular and subcellular units of the raw plant-based material to transform the raw plant-based material into a food ingredient, and reduce water content in the food ingredient.

### CROSS-REFERENCE TO RELATED APPLICATIONS

This application is a divisional application of U.S. application Ser. No. 16/285,223, entitled “UPCYCLING SOLID FOOD WASTES AND BY-PRODUCTS INTO HUMAN CONSUMPTION PRODUCTS”, filed on Feb. 26, 2019, which is a continuation-in-part of, and claims the priority benefit of, U.S. patent application Ser. No. 15/965,992 filed on Apr. 30, 2018, entitled “High-Protein Oilcake-Based Nutritional Composition,” which claims the benefit of U.S. provisional patent application Ser. No. 62/492,367 filed on May 1, 2017, entitled “High-Protein Oilcake-Based Nutritional Composition,” and claims the priority benefit of U.S. provisional application No. 62/736,741, filed on Sep. 26, 2018, entitled “Method and System for Manufacturing Oilcake,” and claims the priority benefit of U.S. provisional application No. 62/713,251, filed on Aug. 1, 2018, entitled “Oilcake-Based Nutritional Ingredients, Products Having High-Protein and High-Fiber Properties, and Methods of Manufacturing Thereof,” which are incorporated herein by reference in their entirety for all purposes.

### TECHNICAL FIELD

This disclosure generally relates to upcycling solid food wastes and by-products. More particularly, this disclosure relates to methods and systems for upcycling solid food wastes and by-products into food-grade nutritional products.

### BACKGROUND

Currently the food waste problem is growing, wasted food occupies more land and emits greenhouse gasses. Upcycling solid food waste is cumbersome due to fiber and liquids trapped in the food waste as well as contamination. Conventional methods of utilizing solid food wastes by composting or by feeding to animals are inefficient and cause greenhouse gas emissions.

Steam flashing, also referred herein to as steam explosion, is a process by which superheated water under pressure is exposed to ambient conditions and immediately evaporates to steam. During the evaporation, the water expands rapidly, thus breaking the internal cavities and creating channels for further moisture release. The flashing caused by extruders occurs at high pressures and temperature, which can effectively sterilize solid food waste. Thus, steam flashing can break fiber to transform the fiber from insoluble into soluble, evaporate water, and sterilize the resulting product, all in just one step.

Primarily, in the food industry, flashing is executed through the use of extruders. There are two types of extruders classified by the number of moving components: single screw extruder and twin screw extruder. Steam flashing is currently used for manufacturing food products such as crisps, cereals, and puffed snacks. However, conventional methods of manufacturing food products do not apply steam flashing to upcycling solid food wastes.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

This disclosure relates to systems and methods for system for upcycling solid food wastes and by-products into food-grade nutritional products and the food-grade nutritional products manufactured by the systems and methods. In an example embodiment, a system for upcycling solid food wastes and by-products into food-grade nutritional products includes an extruder. The extruder may be configured to receive a raw plant-based material and continuously subject the raw plant-based material to steam flashing at predetermined temperature and predetermined pressure. When subjecting the raw plant-based material to steam flashing, the extruder may sterilize the raw plant-based material, destroy antinutrients present in the raw plant-based material, cause a break up of larger cellular and subcellular units of the raw plant-based material into smaller cellular and subcellular units of the raw plant-based material to transform the raw plant-based material into a food ingredient, and reduce water content in the food ingredient.

In an example embodiment, a method for upcycling solid food wastes and by-products into food-grade nutritional products may commence with supplying a raw plant-based material to an extruder. The method may continue with continuously subjecting the raw plant-based material at predetermined temperature and predetermined pressure to steam flashing when supplying the raw plant-based material to the extruder to sterilize the raw plant-based material, destroy antinutrients present in the raw plant-based material, cause a break up of larger cellular and subcellular units of the raw plant-based material into smaller cellular and subcellular units of the raw plant-based material to transform the raw plant-based material into a food ingredient, and reduce water content in the food ingredient.

In an example embodiment, a nutritional product is provided. The nutritional product may include a food ingredient produced from a raw plant-based material by methods and systems mentioned above.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1A illustrates an example steam flashing system.

FIG. 1B illustrates a system for upcycling solid food wastes and by-products into food-grade nutritional products using steam flashing, according to an example embodiment.

FIG. 2 illustrates a system for upcycling solid food wastes and by-products into food-grade nutritional products, according to an example embodiment.

FIG. 3 is a block diagram showing a method for upcycling solid food wastes and by-products into food-grade nutritional products, according to an example embodiment.

FIG. 4 is a block diagram illustrating a food-grade nutritional product, according to an example embodiment.

FIG. 5 is a block diagram illustrating pre-processing and post-processing operations of a method for upcycling solid food wastes and by-products into food-grade nutritional products, according to an example embodiment.

FIG. 6 is a block diagram illustrating pre-processing and post-processing operations of a method for upcycling solid food wastes and by-products into food-grade nutritional products, according to an example embodiment.

FIG. 7 is a block diagram illustrating pre-processing and post-processing operations of a method for upcycling solid food wastes and by-products into food-grade nutritional products, according to an example embodiment.

FIG. 8 illustrates an example system for upcycling solid food wastes and by-products into a nutritional ingredient according to certain example embodiments.

FIG. 9 illustrates an example system for upcycling oilcake and related (derivative) products according to one example embodiment.

FIG. 10A shows results of analysis of an oilcake before processing by a method for upcycling solid food wastes and by-products into food-grade nutritional products.

FIG. 10B shows results of analysis of extruded chips recycled from an oilcake by a method for upcycling solid food wastes and by-products into food-grade nutritional products.

### DETAILED DESCRIPTION

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.” The term “about” shall be construed to mean less or equal to a 20% deviation from a recited value.

As used herein, the term “a nutritional product” means a nutritionally dense product suitable for human consumption. This disclosure relates to upcycling solid food wastes and by-products into food-grade nutritional products which are protein-rich edible products suitable for oral consumption by people. For simplicity, the terms “nutritional product,” “nutritional ingredient,” “food ingredient,” and “food-grade nutritional product can be used interchangeably in this document and, unless otherwise specified, these terms shall be construed to mean one or more of the following: a nutritional powder, nutritional flour, nutritional semi-solids (e.g., nutritional chips or “snacks”), nutritional semi-liquids (e.g., spreads, dips, hummus-like, or yogurt-like products), nutritional liquids, and nutritional shakes. One or more of the above-listed forms of the nutritional product can be reconstructed from one form to another. Furthermore, in view of the different forms of the nutritional product, it can be a ready-to-consume and complete product or serve as an ingredient to produce other products. As used herein, the term “high-protein” means the content of protein from 0.1% to 99.9% in a nutritional product. The “high-protein ingredient” is also referred to herein as “a food ingredient”.

Plant and animal food processing generates a huge amount of by-products and solid food wastes that can be effectively upcycled for human consumption. The methods for upcycling solid food wastes and by-products into food-grade nutritional products described herein apply steam flashing to upcycling solid food wastes and by-products of vegetable oil extraction plants. Upcycling solid food wastes and by-products, such as oilcake or defatted seeds, is hindered due to insoluble fiber, water trapped in the cells, and contaminations contained in the solid food wastes and by-products. In view of this, the solid food wastes are usually composted or fed to animals. Meanwhile, the solid food wastes usually may contain a large percentage of proteins, for example, up to 40%. However, as the fiber contained in the solid food wastes is insoluble, a human organism cannot derive proteins from the fiber consumed by a person.

The term “oilcake” should mean a matter remaining after pressing something to extract the liquids. For example, oilcake is a substance or mass of compressed seed or other plant material left after its oil has been extracted. The terms “oilcake,” “oil cake,” “press cake,” and “meal” are interchangeable and should mean the same.

In the methods and systems described herein, the steam flashing is used to transform insoluble fiber present in the solid food wastes into soluble fiber so that proteins can be derived from the soluble fiber by the human organism upon consuming the soluble fiber by the person. The steam flashing transforms the insoluble input material (e.g., solid food wastes and by-products, such as raw oilcake or a mix of raw oilcake and supplemental ingredients), which is not sterile and not palatable, into a high-protein soluble ingredient, which is substantially sterile and palatable. Therefore, proteins contained in the fiber are made available for human consumption.

The by-products applicable for producing the high-protein ingredient for human consumption include sunflower oilcake (containing 30-40% of proteins), rape seed oilcake (containing 30-40% of proteins), cottonseeds oilcake (containing 30-40% of proteins), oil palm kernel oilcake (containing 17% of proteins), sugarcane pulp (containing 5-15% of proteins), sugar beets pulp (containing 7-12% of proteins), distilled dried grains (corn) (containing 30% of proteins), coffee spent grains (containing 10% of proteins), cocoa beans oilcake (containing 28% of proteins), and the like.

A system for upcycling solid food wastes and by-products into food-grade nutritional products may include an extruder, an optional pneumatic conveyor, and optional post-processing devices. A raw plant-based material may be supplied to the extruder and continuously subjected to steam flashing at predetermined temperature and predetermined pressure. When subjecting the raw plant-based material to steam flashing, the extruder may simultaneously sterilize the raw plant-based material, destroy antinutrients present in the raw plant-based material, cause a break up of larger cellular and subcellular units of the raw plant-based material into smaller cellular and subcellular units of the raw plant-based material, and reduce water content in the food ingredient. Thereby, the raw plant-based material may be transformed into a food ingredient. The pneumatic conveyor may pneumatically transfer the food ingredient to post-processing devices, such as a mill, for further reduction of particle size of the food ingredient. In an example embodiment, the pneumatic conveyor may pneumatically transfer the food ingredient to a packaging device for packaging of the food ingredient. When pneumatically transferring the food ingredient, the pneumatic conveyor may additionally reduce water content in the food ingredient. Therefore, no additional drying device may be needed.

The devices of the system for upcycling solid food wastes and by-products into the food-grade nutritional products may be combined into a single apparatus and may have a size comparable with the size of a home appliance such as a fridge, stove, microwave, or disintegrator such that the system for upcycling solid food wastes and by-products into food-grade nutritional products can be used at home and applicable to household needs. In an example embodiment, the system for upcycling solid food wastes and by-products into food-grade nutritional products can be a tabletop apparatus.

Therefore, steam flashing can be leveraged to transform solid food wastes into nutritionally valuable ingredients. The processing may be include freeing the nutritional elements by destroying the cellulose network. Additionally, the temperature and pressure are capable of destroying pathogens that may otherwise be found in the manufactured high-protein nutritional product. The manufactured food-grade nutritional products provide the potential of feeding people without having to grow any new crops, without requiring additional water or land resources, and without producing additional carbon dioxide.

The methods for upcycling solid food wastes and by-products food-grade nutritional products of this disclosure were also unexpectedly found to be inexpensive and efficient. These methods ensure that the food ingredient is of a high quality and free from allergens, gluten, toxins, and fungus. The present methods allow for producing the protein-based products more than ten times less expensive than the traditional way of exploiting animals, such as cows, to produce conventional animal-based protein sources. Moreover, the present methods are more sustainable for the planet environment as they require a significantly reduced use of land and reduced gas emissions comparing to the traditional animal-based protein production methods.

The food ingredient at the output of steam flashing device is allergen-free and rich in protein and fiber. For example, flour produced by using the above method from sunflower oilcakes can contain about 35% of protein, about 45-50% of carbohydrates, about 15-20% of fiber, about 0% of sugars, and about 0-1% of fats. This is an unexpected result.

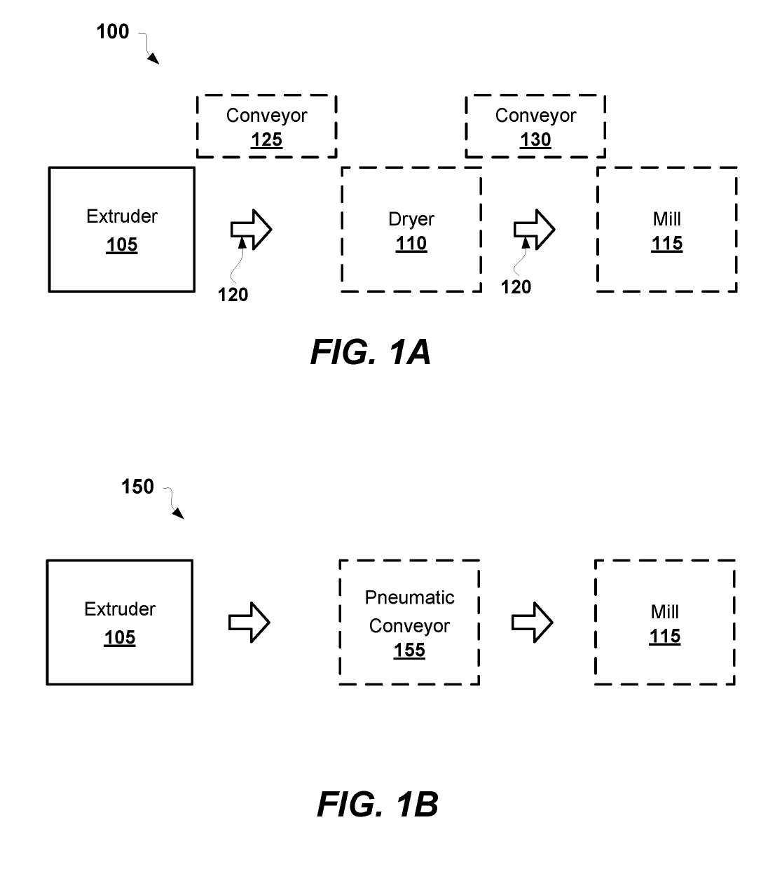

Referring now to the drawings, FIG. 1A is a block diagram illustrating an example steam flashing system 100. The system 100 may be used to create the upcycled flour in a stable, commercial form. The system 100 may include an extruder 105 and may, optionally, include a drier 110 and a mill 115. The extruder 105 is used to free protein, reduce water, functionalize fiber, and reduce biological load (i.e., kill bacteria) in the sunflower cake. In some embodiments, the extruder 105 is further configured to process the food ingredient into cereal, pasta, puree, and similar products. The dryer 110 is needed to reduce water and stabilize the product. The mill 115 is used to reduce the particle size to the size useful for a customer putting this ingredient into food.

Additionally, arrows 120 represent a conveyance system shown as a conveyor 125 and a conveyor 130 (the conveyor 125 and the conveyor 130 may be optional in the system 100). In industrial applications, extruders are not located in the same areas of the plant as mills. In particular, there is a risk of cross-contamination of food-grade plant-based materials from feed-grade plant-based materials. In view of this, the feed-grade plant-based materials are not allowed not only for use, but even to be present in the food manufacturing facility because of risk of cross contamination. The path of transportation between the extruder 105 and the dryer 110 and between the drier 110 and the mill 115 is sizable. According to the rule of thumb applicable in the industry, bucket, belt, and chain conveyors do not make economic sense when the conveyors are 100 feet or longer.

In the systems and methods described herein conveyors 125 and 130 may be replaced with pneumatic conveyance. FIG. 1B is a block diagram illustrating a system 150 for upcycling solid food wastes and by-products into food-grade nutritional products using steam flashing. When using pneumatic conveyance, the solid material is pushed through a pipe with high velocity air. The solid material is introduced to the pipe through an airlock valve. The solid material is shuttled around through the use of valves, boosters, and finally collection bins. Since this air is in contact with the solid material, the air for the system 150 is cleaned and conditioned before its use in the pneumatic conveyance. Conditioning of air means controlling the temperature and the humidity (related to moisture content) of the air.

When comparing with the system 100, in the system 150 of FIG. 1B two conveyors 125 and 130 and the drier 110 are replaced with a single pneumatic conveyor shown as a pneumatic conveyor 155. The pneumatic conveyor 155 accomplishes the same set of effects on the solid material, namely reduces water content and stabilizes the solid material, as well as also transfers the solid material from the extruder 105 to the mill 115 at the same time.

Additionally, to avoid the risk of cross-contamination of food-grade plant-based materials by feed-grade plant-based materials, the feed-grade by-products may be extruded in one building, and then the extruded ingredients, e.g., in form of crisps, can be brought to a food-grade milling facility in another building. Because the ingredients extruded by the extruder are sterile, the ingredients extruded from the feed-grade by-products cannot contaminate the food-grade plant-based materials also supplied to the food-grade milling facility.

The applicable conditions for the air include hot and dry air. The hot air allows more moisture from the extruded product to migrate into the air, in a similar manner as a fluidized bed dryer. Specifically, in addition to a filter on the pneumatic air intake, a chiller is needed to bring the moisture down and a heater is needed to standardize the inlet air temperature.

Additionally, the costs of the equipment shown on FIG. 1A are high due to high transportation costs to deliver the solid material to shared processing facility and short time window for upcycling wet by-products (2-3 days due to microbiology activity). The system 150 shown on FIG. 1B may be implemented in form of cost-efficient medium systems for use at small foodservice facilities, such as coffee shops, juicers, bakeries, small farms, etc., and mini systems for individual/home use along/instead of a solid food waste disintegrator in a kitchen sink. For cleaning purposes, in an example embodiment of the system 150 where the system 150 is a small tabletop-size apparatus, the system 150 may have replaceable cartridges with screws, which can be regularly replaced to extrude the raw plant-based material using clean screws of the extruder.

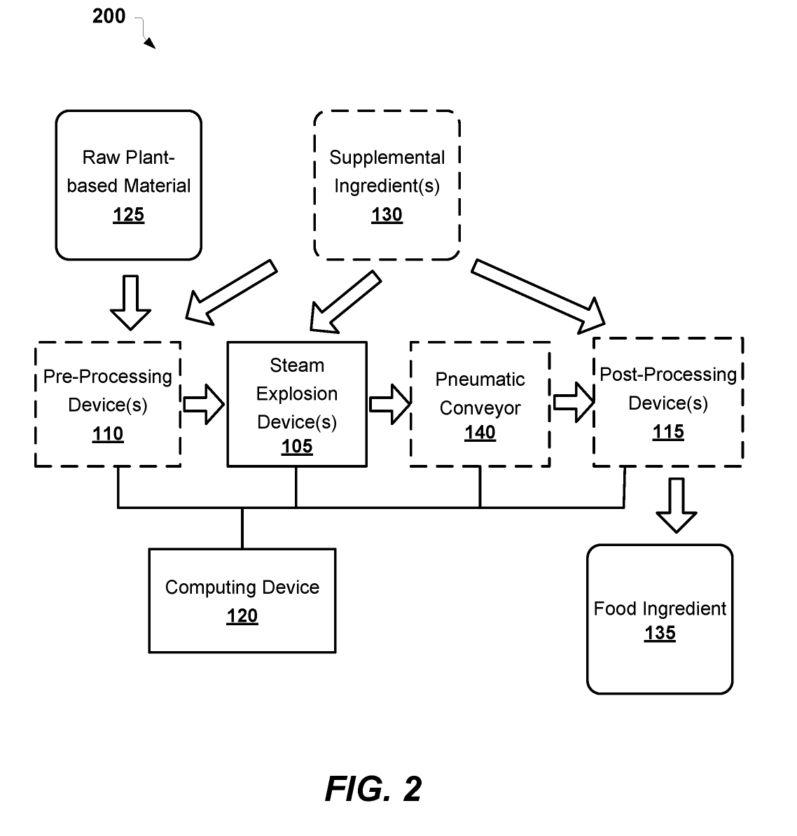

FIG. 2 illustrates an example system 200 for upcycling solid food wastes and by-products into food-grade nutritional product according to an example embodiment. As shown in FIG. 2, system 100 may include a steam explosion device 105 (also referred to a steam flashing device) and, optionally, a pneumatic conveyor 140. The steam explosion device 105 may be implemented in the form of an extruder. In further example embodiment, the steam explosion device 105 may include a heating device, a microwaving device, a frying device, and the like. This disclosure is focused on the use of an extruder solely as an example and not a limitation. The steam explosion device 105 may receive raw plant-based material 125 (e.g., one or more oilcakes as discussed herein). Optionally, the raw plant-based material 125 may be pre-processed by one or more pre-processing devices 110. Additionally, one or more supplemental ingredients 130 may be added to the raw plant-based material 125 at any step of processing. In an example embodiment, the raw plant-based material 125 includes solid food wastes and/or by-products.

The solid food wastes may be selected from a group comprising: a sorted solid food waste, an unsorted solid food waste, a food grade solid food waste, a feed grade solid food waste, a plant-based solid food waste, a pure solid food waste, and a solid food waste mixed with one or more of the following: further ingredients, nutrients, chemicals, and so forth. The solid food wastes may further include plant stalks, leaves, processed wood, cellulose-based products, and the like. The plant-based solid food wastes may include nuts and peanuts (shell waste, hulls, pomace), fruits (peel, pomace, pulp, defective fruits), berries (defective berries, stems, pulp), vegetables (peel, pomace, pulp, defective vegetables, peeled waste cuts), citrus (peel, pulp, seeds), coffee (pulp, spent grains), oil crops (oilcakes), beans (beans skin and pods, defective beans), leafy greens (loose leaves), grains (spent brew grains, distiller dried grains and solids, yeast waste), cereals (hulls, bran), mushrooms (defective mushrooms, small species), sugar beets (pulp, molasses), and the like.

The by-products may be selected from a group comprising: a by-product of animal processing, a by-product of fish processing, an insect, a cricket, a worm, bacteria, microorganisms (yeast species, cultured meats, genetically modified organisms), and a by-product of processing the solid food wastes by one of more of the following: the insect, the cricket, the worm, the bacteria, and so forth. The by-products may include raw oilcake, for example, sunflower oilcake, soybean oilcake, cotton seed oilcake, rapeseed oilcake, canola oilcake, copra meal, palm kernel oilcake, olive oilcake, peanut oilcake, and so forth.

In some embodiments, there can be provided two or more steam explosion devices 105 connected in series. The steam explosion device 105 continuously subjects the raw plant-based material 125 to steam flashing at predetermined temperature and predetermined pressure. In an example embodiment, the predetermined temperature is 140 to 160° C. and the predetermined pressure is 20 to 80 bar. When subjecting the raw plant-based material 125 to steam flashing, the steam explosion device 105 sterilizes the raw plant-based material, thereby reducing biological load of the raw plant-based material 125 and reducing the number of microorganisms in the raw plant-based material 125. Furthermore, when subjecting the raw plant-based material 125 to steam flashing, the steam explosion device 105 destroys antinutrients present in the raw plant-based material. The antinutrients are plant compounds that reduce the ability of a human body to absorb nutrients. Example antinutrients include mycotoxins, phytates, tannins, lectins, protease inhibitors, calcium oxalates, and so forth. Furthermore, when subjecting the raw plant-based material 125 to steam flashing, the steam explosion device 105 causes a break up of larger cellular and subcellular units of the raw plant-based material into smaller cellular and subcellular units of the raw plant-based material. As a result, the steam explosion device 105 transforms the raw plant-based material 125 into a food ingredient. Furthermore, when subjecting the raw plant-based material 125 to steam flashing, the steam explosion device 105 reduces water content in the food ingredient. The steam explosion device 105 passes the food ingredient to the pneumatic conveyor 140. The pneumatic conveyor 140 pneumatically transfers the food ingredient to one or more post-processing devices 115. In an example embodiment, the post-processing device 115 may include a mill, a pasteurization device, and so forth.

When an extruder is used as the steam explosion device 105, the extruder can include a housing and one or more mixing screws contained therein. The mixing screws are normally cleaned after every run. If not cleaned, the mixing screws can plug a barrel of the extruder. It is hard to clean the extruder if the barrel is plugged. To avoid plugging, the mixing screws can be replaceable, in particular, in an embodiment when the system 150 is a tabletop apparatus. In an example embodiment, a combination of the barrel and the mixing screws may be replaceable. The mixing screws feed the raw plant-based material through a small opening, where a mechanical force creates a high temperature and pressure. The high temperature and pressure at the opening causes steam flashing of the raw plant-based material causing a break up of large or long molecular chains. This process sterilizes and makes ingredients palatable, and thus protein available for human consumption at the output of the extruder. The operation of extruder can be monitored by a computing device 120, which can monitor and control a rotational speed, a temperature inside the extruder, and other parameters based on sensor measurements, operation protocol, or an input of an operator.

In an example embodiment, the mill may be located in a first plant facility and the extruder may be located in a second plant facility. The first plant facility and the second plant facility may be located at locations remote with respect to each other to avoid cross-contamination. In particular, the feed-grade materials can be processed by the extruder at a first location and transported to the mill located at a second location. The food ingredient obtained from the extruder and transported to the mill is sterile and, therefore, cannot contaminate the food-grade ingredients that can be also provided to the mill.

An input of the steam explosion device 105 may be operatively and directly connected to one or more optional pre-processing devices 110. The pre-processing devices 110 can include, without limitation, one or more mixers, grinders, cutting devices, dispensing devices, moisturizing devices, supplying devices, transporting devices, dosing devices, and so forth. It should be understood that one or more pre-processing devices 110 may perform one or more pre-processing operations such as moistening by mixing the raw plant-based material 125 with water or other liquids. It can also provide mixing raw plant-based material 125 with optional supplemental ingredients 130. One or more pre-processing devices 110 can also perform heating, cooling, compressing, decompressing, feeding, pressing, supplying, or any other similar operation against the raw plant-based material 125 including one or more supplemental ingredients 130.

The post-processing devices 115 may be connected to an output of the pneumatic conveyor 140. The post-processing devices 115 may receive the food ingredient from pneumatic conveyor 140 and perform one or more optional post-processing operations. Example post-processing operations include, without limitation, one or more of the following: pasteurization, milling, mixing, grinding, cutting, hot oil or hot air expanding, popping, puffing, drying, and coating. As shown in the FIG. 2, the supplemental ingredients 130 can be optionally introduced (and mixed) at any production stage, i.e., to the pre-processing devices 110, steam explosion device 105, pneumatic conveyor 140, or post-processing device 115. An output of the pneumatic conveyor 140, or post-processing devices 115 (if the post-processing is used), is the food ingredient 135.

The system 200 can further include the computing device 120 and one or more sensors for controlling the operation of any or all devices used in system 200. The computing device 120 may be configured to run software or a protocol to automatically control, adjust, and execute pre-programmed operations of the system 200 at preferred parameters so as to make sure that the generation of the food ingredient 135 is within predetermined or preferred regime. For example, sensors can measure a temperature and a conveying speed of the extruder, while computing device 120 can adjust operation of any of pre-processing devices 110, the extruder, or post-processing devices 115 to make sure that the food ingredient 135 is of predetermined quality or has predetermined parameters (e.g., that it became sterile and palatable).

In an example embodiment, the extruder (shown as the steam explosion device 105), the pneumatic conveyor 140, post-processing device 115 (e.g., a mill), and pre-processing devices 110 may be implemented in a form of a single apparatus. In an example embodiment, the system 200 may be a tabletop system for household use, a system sized for foodservice facilities, such as a coffee shop, a juicer, a bakery, a cage, a shop, a retail facility, a commercial facility, a small farm, and so forth. Furthermore, the system 200 may be a system sized for individual use or for being used along with or instead of kitchen appliances, such as a solid food waste disintegrator of a kitchen sink.

In an example embodiment, the extruder may be configured to perform a plurality of pre-processing and post-processing operations. For example, the extruder may have a chilling section in the barrel and may further have a special die to make pasta and extrude pasta straight from the extruder. In another example embodiment, the extruder may further include an ultra-high pasteurization device to make the hummus-like dip, spread, and puree.

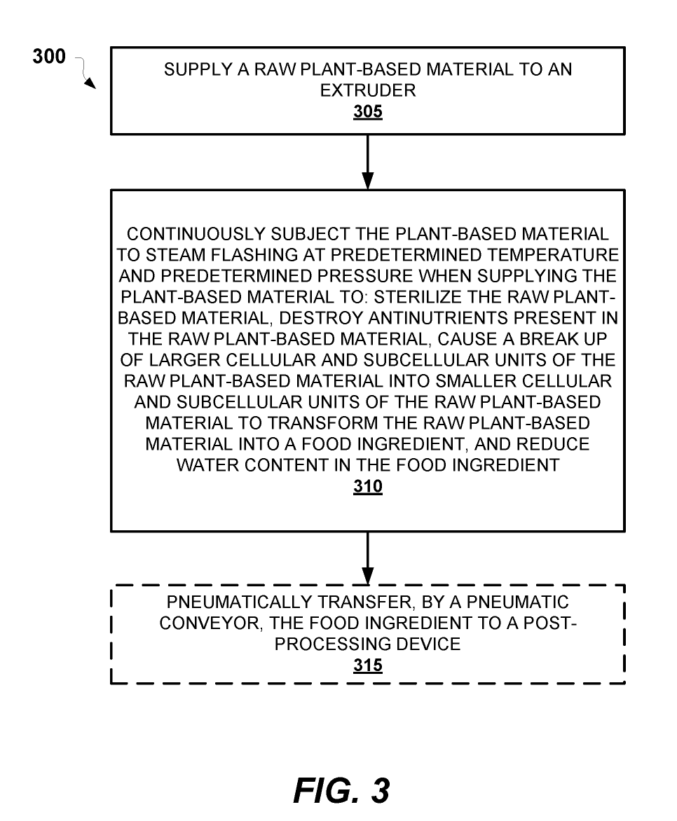

FIG. 3 is a block diagram showing a method 300 for upcycling solid food wastes and by-products into food-grade nutritional products according to an example embodiment. The method 300 may be performed by processing logic that may comprise hardware, software, or a combination of both. In one example embodiment, the processing logic refers to system 200 or its components. Below recited operations of the method 300 may be implemented in an order different than described and shown in the figure. Moreover, the method 300 may have additional operations not shown herein, but which can be evident for those skilled in the art from the present disclosure. The method 300 may also have fewer operations than outlined below and shown in FIG. 3.

The method 300 may commence with supplying a raw plant-based material to an extruder at operation 305. The method 300 may continue with operation 310, at which the raw plant-based material may be continuously subjected to steam flashing at predetermined temperature and predetermined pressure when supplying the raw plant-based material to the extruder. When subjecting the raw plant-based material to steam flashing, the extruder sterilizes the raw plant-based material. Furthermore, the extruder destroys antinutrients present in the raw plant-based material and causes a break up of larger cellular and subcellular units of the raw plant-based material into smaller cellular and subcellular units of the raw plant-based material. As a result of the steam flashing, the raw plant-based material may be transformed into a food ingredient. Furthermore, when subjecting the raw plant-based material to steam flashing, the extruder reduce water content in the food ingredient. The food ingredient is obtained not by isolation from the input raw plant-based material, but rather by transforming the raw plant-based material into the processed ingredient by the steam flashing process, such as by extrusion at a high temperature and high pressure. Therefore, when subjecting the raw plant-based material to the steam flashing, the extruder automatically destroys pathogens, such as bacteria viruses, and fungi, in the raw plant-based material. The steam flashing may be provided by devices configured to perform the following operations: extruding, frying, heating, microwaving, puffing, air popping, and so forth.

In case of extruding, a 42-inch Twin Screw extruder can be used at step 310. Its example operating parameters can include: (a) dry feed rate is about 200 kg/h; (b) a water rate is about 14% of the dry feed rate; (c) a screw speed is at least 500 rpm; and (d) a barrel temperature profile is as follows: Barrel 1 is at room temperature or cooled, while Barrels 2, 3, and 4 are kept at the temperature of more than 100° C.

The method 300 may further include operation 315, at which a pneumatic conveyor may pneumatically transfer the food ingredient to a post-processing device. In some example embodiment, the pneumatic conveyor may, optionally, reduce water content in the food ingredient.

Optionally, the method 300 may include pre-processing of the raw plant-based material before supplying the raw plant-based material to the extruder. The pre-processing may include one or more of the following: pre-sterilization, antinutrients elimination (such as mycotoxin elimination), drying, moisturizing, mixing the input material with water or other liquids, heating, pressing, grinding, cutting, conveying, and so forth. The pre-processing devices may be attached directly to the extruder and can be loaded by transport, from a collection bunker or manually.

Thus, the output of method 300 is the food ingredient ready for human consumption, which can be used as the main or the only ingredient of the nutritional product of this disclosure. In a further example embodiment, the food ingredient may be used as an additive to a hybrid meat, an additive to pet foods, and so forth.

In some example embodiments, prior to supplying the raw plant-based material to an extruder, the raw plant-based material may be subjected to pre-processing by one or more of the following: insects, crickets, warms, bacteria, and so forth. For instance, not sorted solid food wastes can be fed to black soldier fly, and then effectively upcycled and sterilized using the method 300 for human consumption (without protein isolation). Upon being pre-processed by the insects, crickets, and bacteria, the pre-processed raw plant-based material, together with the insects, crickets, and bacteria, may be supplied to the extruder. The insects, crickets, warms, and bacteria are known to be a protein source.

Additionally, the method 300 may include receiving and mixing one or more optional supplemental ingredients with the raw plant-based material. The supplemental ingredients can include one or more of the following: carbohydrates, proteins, and fats. Proteins can include any suitable plant-based or animal-based proteins. Fats can include oils. For example, the supplemental ingredients can include potato starch or starch derived from one or more of the following: grains, tubers, tapioca, and cassava. The supplemental ingredients can also include flour derived from one or more of the following: rice, corn, wheat, rye, garbanzo, black beans, and pinto beans. The supplemental ingredients can include vitamins, minerals, and food agents, such as vitamin A, vitamin C, vitamin D, vitamin E, vitamin K, thiamine, riboflavin, pyridoxine, vitamin B12, carotenoids, niacin, folic acid, pantothenic acid, biotin, choline, inositol, salts, and derivatives thereof, flavoring agents, preservatives, stabilizers, colorants, and the like.

A ratio between the food ingredient and the supplemental ingredient can be in the following ranges: from about 1% to about 99.9% of the food ingredient and from about 0.01% to about 99% of the supplemental ingredient. These ratios were proven to effectively provide protein-rich nutritional products, which, unexpectedly, are easily digested by most population groups and do not lead to obesity issues.

As the raw plant-based material may be dry (e.g., it may contain less than 10% of water by weight), the method 300 may optionally include moistening of the raw plant-based material to produce a moistened plant-based material. The moistening operation is optional. The moistening may involve adding water or other liquids (e.g., purified water, spring water, milk, juice, nutritionally rich liquids, etc.). The moistening can be performed until the moistened plant-based material contains about 25-32% by weight of water. In addition, the moistening can be performed automatically by a pre-processing device such as a mixer and an input conveyor. In yet other embodiments, the moistening can be combined with any other pre-processing operation or performed in an extruder. In some embodiments, there can be employed one or more sensors to measure a moisture level of the raw plant-based material before and after moistening to ensure automatic moistening to a predetermined degree. The sensors can be coupled to a computing device, which can monitor and control the moistening.

Optionally, the method 300 may include post-processing of the food ingredient. The post-processing may include one or more of the following: milling, grinding, cutting, drying, frying, concentrating, sterilization, baking, pasteurization, biological load reduction, supplementing with nutrients and/or chemicals, seasoning, mixing with liquids and mixing with one or more optional supplemental ingredients, and so forth. Further, the post-processing operations can include dispensing, packaging, bottling, cooking, and the like. In example embodiments, the method 300 may further include post-processing of the food ingredient into one or more of the following: flour, patty, puree, dip, spread, a flour-like product, chips, a chips-like product, pasta, noodles, ramen, a pasta-like product, and so forth.

The devices used for pre-processing and post-processing may include built-in drying devices (tunnel, microwave, Infra-Red, vacuum, hot air at pneumatic transport, fluidized bed dryers, etc.), built-in milling devices (special die design, cutter as the mill), built-in concentration devices for separating nutrients for fractions (e.g., high protein/high fiber fraction), built-in sterilization devices, biological load/microorganism count reduction devices, the extruder having one or more screws and different screw configurations, built-in devices for supplementing other nutrients/chemicals, built-in seasoning devices, built-in baking device, built-in patty making/sausage filling devices, built-in pasta/noodles making devices, built-in frying devices, built-in puree/dip/spread making devices, built-in drink pasteurization/making devices, built-in self-cleaning devices or replaceable elements (such as cartridges with screws), built-in devices performing two or more above-mentioned operations at a time, built-in computing devices for automatic control, adjustment and execution of pre-programmed operations. Each of these devices can be operated manually or remotely. In an example embodiment, the pre-processing devices and the post-processing devices may be built into an extruder.

Various parameters of the method 300 can be constantly monitored by a computing device and adjusted to make sure that a ratio between the food ingredient and at least one supplemental ingredient is within a predetermined range. As such, the nutritional product (composition) produced by the method 300 is suitable for human consumption and includes from about 1% to about 99.9% of the food ingredient and from about 0.1% to about 99% of at least one supplemental ingredient. Some example ratios are as follows: (1) about 25% of the food ingredient and about 75% of at least one supplemental ingredient; (2) about 50% of the food ingredient and about 50% of at least one supplemental ingredient; (3) about 75% of the food ingredient and about 25% of at least one supplemental ingredient; (4) about 99% of the food ingredient and about 1% of at least one supplemental ingredient; (5) about 95% of the food ingredient and about 5% of at least one supplemental ingredient; (6) about 90% of the food ingredient and about 10% of at least one supplemental ingredient; (7) about 80% of the food ingredient and about 20% of at least one supplemental ingredient; (8) about 70% of the food ingredient and about 30% of at least one supplemental ingredient; (9) about 60% of the food ingredient and about 40% of at least one supplemental ingredient; and so forth. At least some of the above ratios were unexpectedly found to provide protein-rich nutritional products in effective and inexpensive manner, and where the protein-rich nutritional products are easily digested by most human population groups.

As discussed above, the steam flashing process transforms the input material (e.g., raw oilcake or a mix of raw oilcake and one or more supplemental ingredients), which is not sterile and not palatable, into the high-protein material (e.g., the processed oilcake), which is substantially sterile and palatable. The following two examples illustrate the sterilization upon applying the method 300.

Example No. 1: As an input material (raw oilcake), sunflower oilcake collected on Jun. 27, 2017 was supplied to an extruder (e.g., the 42-inch Twin Screw extruder discussed above). An aerobic plate count of input material was about 49,000 CFU/g, a coliform bacteria level was about 460 CFU/g, an E. coli (non-pathogenic) level was less than 10 CFU/g, a mold level was about 7,000 CFU/g, a yeast level was at about 80 CFU/g, and tests on listeria species and salmonella were negative. As an output from the extruder, the processed oilcake was obtained from the input material on Jul. 5, 2017. The aerobic plate count of processed oilcake was less than 10 CFU/g, the coliform bacteria level was less than 10 CFU/g, the E. coli (non-pathogenic) level was less than 10 CFU/g, the mold level was less than 10 CFU/g, the yeast level was less than 10 CFU/g, and tests on listeria species, salmonella, and aflatoxin were negative.

Example No. 2: As an input material (raw oilcake), sunflower oilcake collected on Jun. 17, 2017 was supplied to an extruder (e.g., the 42-inch Twin Screw extruder discussed above). The aerobic plate count of the input material was about 75,000 CFU/g, the coliform bacteria level was at about 370 CFU/g, the E. coli (non-pathogenic) level was less than 10 CFU/g, the mold level was at about 17,000 CFU/g, the yeast level was at about 16,000 CFU/g, and tests on listeria species and salmonella were negative. As an output from the extruder, the processed oilcake in the form of chips was obtained from the input material on Dec. 12, 2017. The aerobic plate count of processed oilcake was less than 10 CFU/g, the coliform bacteria level was less than 10 CFU/g, the E. coli (non-pathogenic) level was less than 10 CFU/g, the mold level was less than 10 CFU/g, the yeast level was less than 10 CFU/g, and tests on listeria species, salmonella, and aflatoxin were negative.

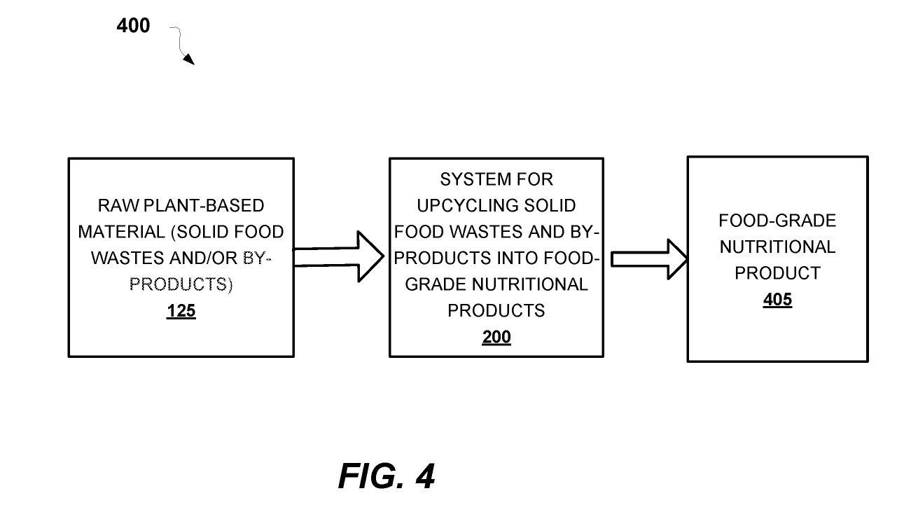

FIG. 4 is a block diagram 400 illustrating a food-grade nutritional product 405, according to an example embodiment. The food-grade nutritional product 405 may include a food ingredient produced from a raw plant-based material 125 using a system 200 shown on FIG. 2. Specifically, the food-grade nutritional product 405 may be manufactured by supplying the raw plant-based material to an extruder, continuously subjecting the raw plant-based material to steam flashing to transform the raw plant-based material into a food ingredient and pneumatically transferring the food ingredient to a post-processing device. The raw plant-based material supplied to the extruder may include solid food wastes and by-products. The manufactured food-grade nutritional product 405 may be a nutritional substance ready for human consumption. The food-grade nutritional product 405 may have one of the following forms: a crisp form, a granulated form, a pelletized form, and so forth. In an example embodiment, a palletizer may be used to palletize the food-grade nutritional product 405. The palletizer may be a separate device relating to a class of equipment different from the extruder.

The food-grade nutritional product 405 may further include at least one supplemental ingredient, such as carbohydrates, proteins, and fats. The content of the food ingredient may be from 1% to 99.9%, and the content of the at least one supplemental ingredient may be from 0.01% to 99%.

The food-grade nutritional product 405 may be prepared by upcycling solid food wastes is a valuable human consumption ingredient for at an affordable price. For example, the food-grade nutritional product 405 in form upcycled from sunflower oilcake has the price of all-purpose flour, but provides 3 times more protein and 10 times more fiber.

The food-grade nutritional product 405 may be applied in recipes by replacing 30% of all-purpose flour with the food-grade nutritional product 405 in form of the flour obtained from processed oilcake. This may double the protein and fiber content in the flour mixture and may keep the texture, flavor, and costs of the flour the same.

In another example applications, fortification of a nutritional product with food ingredients can turn baked products into a product having an increased content of proteins and fiber as compared to traditional nutritional products.

The food-grade nutritional product 405 may be effectively applied in bakery and cooking, e.g., for preparing bread, tortilla, pancake, flapjack, brownie, cookie, pretzel, baking mixtures, pasta, ramen, puree, hummus, spread, dip, paste, protein bar, soup, snack, cereal, and so forth. The food-grade nutritional product 405 may be further applied in alternative meats and meat replacement, dips and spreads, hummus and puree, gravies, confectionary, frozen meal, meal replacement, desserts, and so forth.

In example embodiments, the food-grade nutritional product 405 may be applied in pizza, burgers and sandwiches (e.g., burgers, chicken/turkey sandwiches, egg/breakfast sandwiches, other sandwiches, burritos and tacos), meat, poultry, seafood mixed dishes (including stir-fry and soy-based sauce mixtures), rice, pasta, and other grain-based mixed dishes (including rice mixed dishes, pasta mixed dishes, macaroni and cheese, turnovers and other grain-based items, fried rice, egg rolls, dumplings, sushi, other Mexican mixed dishes), soups, pasta, noodles, cooked grains, yeast breads, rolls and buns, bagels and English muffins, tortillas, quick breads (such as biscuits, muffins, quick breads, pancakes, waffles, French toast), breakfast cereals and bars (such as ready-to-eat cereal, oatmeal, grits and other cooked cereals, cereal bars, nutrition bars), snacks and sweets, chips, crackers, and savory snacks (such as potato chips, tortilla, corn, other chips, popcorn, pretzels/snack mixtures, crackers, saltine crackers, nachos), desserts and sweet snacks (such as cakes and pies, cookies and brownies, doughnuts, sweet rolls, pastries, ice cream and frozen dairy desserts, pudding, gelatins, ices, sorbets), candies and sugars (such as candy containing chocolate, candy not containing chocolate, sugar substitutes, jams, syrups, toppings), vegetables (such as pasta sauces, tomato-based sauces, vegetable mixed dishes, beans and peas), starchy vegetables (such as French fries and other fried white potatoes, mashed potatoes and white potato mixtures), nutritional beverages, condiments, gravies, spreads, salad dressings (such as tomato-based condiments, dips, gravies, other sauces, mayonnaise, vegetable oils), protein foods (such as texturized vegetable proteins, frankfurters, sausages, patties), and the like.

Upon performing one or more additional post-processing operations, the food-grade nutritional product 405 may be in a dry form (for example, crisps and flour), semi-dry form (for example, sausage, dip, and spread), and liquid form (such as purees and drinks).

In a further example embodiment, the manufactured high-protein nutritional product may be used as a plant-based medium for animal-free food growing (also known as clean meats) and as food for synthetic biology applications.

An example food ingredient, or a high-protein ingredient, upcycled from by-products includes defatted soy flour. The defatted soy flour has beany taste, aroma typical for soybeans and may be textured from a fine powder to a coarse powder, and colored from white to yellow. The content of proteins can be around 51.0%, and the content of fiber can be around 17.5%. The defatted soy flour is available in both Genetically Modified Organisms (GMO) and GMO-free versions.

Another example of high-protein gradient upcycled from by-products includes defatted sunflower seeds in the form of crisps. The crisps can have nutty taste, aroma typical for sunflower seeds, may be textured from medium-hard to hard, and colored dark brown. The content of proteins can be around 35.0%, and the content of fiber can be around 18.0%. The crisps can be available in a GMO-free and allergen free versions.

Another example of a high-protein gradient upcycled from by-products includes defatted sunflower seeds in the form of flour. The flour has nutty taste, aroma typical for sunflower seeds, may be textured from ultra-fine powders to coarse powders, and colored dark brown. The content of proteins can be around 35.0%, and the content of fiber can be around 18.0%. The flour can be available in GMO-free and allergen free versions.

Another example of a high-protein gradient upcycled from by-products includes wheat flour. The wheat flour has a neutral taste and neutral aroma, may be textured from ultra-fine powders to coarse powders, and colored white. The content of proteins is around 10.0%, and the content of fiber is around 2.7%. The wheat flour is available in a GMO-free version.

In an example embodiment, the recommended amount of substitution of ingredients in products with a high-protein nutritional ingredient is about 30%. For example, when used in potato chips, the high-protein nutritional ingredient may constitute 20%, if upcycled flour is used, and 60% if potato pills are used. The high-protein nutritional ingredient may constitute up to 70% in potato snacks, 70% in nuts and seeds (if upcycled nuts and seeds pomace is used), 20% in traditional savory snacks if upcycled flour is used, 50% in traditional savory snacks if fruits, berries, or vegetal pulp are used), and 20% in meat snacks.

When used in breakfast foods, the high-protein nutritional ingredient may constitute up to 20% in madeleine cookies, 20-30% in muffins, 20-30% in pain au chocolate, 20-30% in pain aux raisins, 30% in pancakes, up to 20% in scones, up to 20% in toaster pastries, 30% in waffles, up to 30% in other breakfast foods and frozen breakfast foods, up to 30% in crumpets, 20-30% in donuts, and 20-30% in croissants.

When used in breads, the high-protein nutritional ingredient may constitute up to 30% in loaves and baguettes, 30% in rolls and burger buns, up to 30% in sandwich slices, ciabatta, frozen breads, and other breads. The high-protein nutritional ingredient may constitute 30% in cakes and 10-30% in pastries and sweet pies. The high-protein nutritional ingredient may constitute 20-50% in pasta and 20-30% in noodles. When used in breakfast cereals, the high-protein nutritional ingredient may constitute 20-30% in hot cereals and 30-70% in ready-to-eat cereals.

When used in crackers and savory biscuits, the high-protein nutritional ingredient may constitute 20-70% in bread substitutes, 20-40% in cheese-flavored crackers, up to 30% in plain crackers, and up to 70% on other crackers. When used in meat, the high-protein nutritional ingredient may constitute 10-30% in hybrid meat and meat substitutes, 50-70% in breading for the meat, and 10-30% in flexitarian meals. The high-protein nutritional ingredient may constitute 20-30% in spreads, puree, and dips.

In an example embodiment, the upcycled high-protein nutritional ingredient may be used in pet food, such as semi-liquid pet food and dry pet food. Specifically, the semi-liquid pet food may be fortified with upcycled high-protein nutritional ingredients, and dry pet food may be made from texturized proteins from upcycled ingredients and/or fortified with upcycled ingredients.

In an example embodiment, a nutritional product suitable for human consumption may include a food ingredient produced by a process involving crushing of water-insoluble solid food wastes or water-insoluble by-products or milling of the water-insoluble solid food wastes or the water-insoluble by-products. The nutritional product may further include one or more supplemental ingredients, such as carbohydrates, proteins, and fats, and so forth.

In an example embodiment, a nutritional product for human consumption may include from about 1% to about 80% of a food ingredient and from about 20% to about 99% of a supplemental ingredient. The food ingredient may be produced by a process involving steam flashing of a water-insoluble raw plant-based material, crushing of the water-insoluble raw plant-based material, or milling of the water-insoluble raw plant-based material. The supplemental ingredient may include a flour, an active dry yeast ingredient, a vegetable oil ingredient, and one or more additional ingredients. The flour may be selected from one or more of the following: an all-purpose flour, a bread flour, a wheat flour, a rye flour, a spent grain flour, a rice flour, a spelt flour, a barley flour, an oat flour, an amaranth flour, a nut flour, and so forth.

The one or more additional ingredients may be selected from one or more of the following: a salt ingredient, a sugar ingredient, a spice ingredient, and the like. The food ingredient and the supplemental ingredient may be processed into at least one of the following forms: cereal, dips, spreads, pasta, noodles, puree, pizza, burgers, sandwiches, grain-based mixed dishes, soups, cooked grains, yeast breads, rolls, buns, bagels and English muffins, tortillas, quick breads, breakfast cereals, breakfast bars, snacks, sweets, chips, crackers, savory snacks, desserts, sweet snacks, candies, sugars, vegetables, starchy vegetables, nutritional beverages, condiments, gravies, spreads, salad dressings, protein foods, and the like.

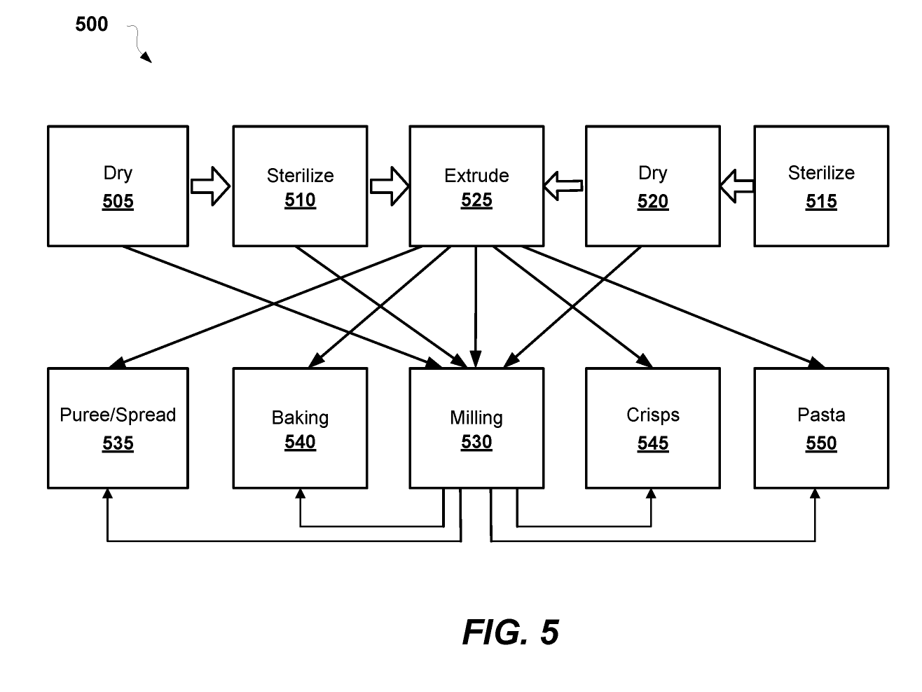

FIG. 5 is a block diagram 500 illustrating a plurality of pre-processing and post-processing operations of the method for upcycling solid food wastes and by-products into food-grade nutritional products. At least a portion of a raw plant-based material may be dried at operation 505 and sterilized at operation 510. Another portion of the raw plant-based material or another type of the raw plant-based material may be first sterilized at operation 515 and then dried at operation 520. After operations 510 and 520, the raw plant-based material may be supplied to the extruder and processed by the extruder at operation 525.

The raw plant-based material processed into a food ingredient by the extruder may be transported to a mill to perform milling at operation 530. In example embodiment, the milling may be performed after any of operations 505, 510, and 520. In this embodiment, the milled raw plant-based material may be transported to the extruder.

Upon processing the raw plant-based material into the food ingredient by the extruder, or, in some example embodiments, upon milling the food ingredient by the mill, the food ingredient may be post-processed. Specifically, the post-processing may include processing the food ingredient into a puree/spread at operation 535, baking at operation 540, processing into crisps at operation 545, and processing into pasta at operation 550.

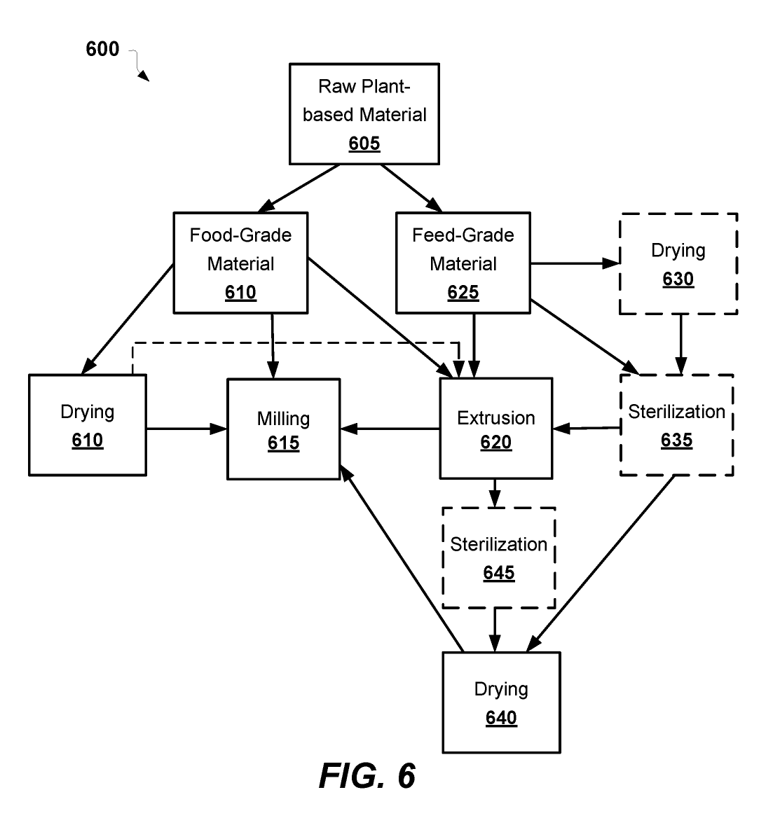

FIG. 6 is a block diagram 600 illustrating a plurality of pre-processing and post-processing operations of the method for upcycling solid food wastes and by-products into food-grade nutritional products. The raw plant-based material 605 may be supplied in different forms, e.g., solid food wastes and by-products. A portion of the raw plant-based material may include a food-grade material 610 may be dried at operation 615 and/or milled at operation 615. After drying, the portion of the food-grade material 610 may be processed by the extruder at operation 620.

A further portion of the raw plant-based material may include a feed-grade material 625 and may be optionally pre-processed by drying at operation 630 and sterilized at operation 635. The further portion of the feed-grade material 625 may be provided to the extruder to be processed by the extruder at operation 620. After sterilization at operation 635, the further portion of the feed-grade material 625 may be dried at operation 640 and provided to the mill to be milled at operation 615. Furthermore, the food ingredient obtained at operation 620 may be optionally sterilized at operation 645, dried at operation 640, and provided to the mill to perform the milling of the food ingredient at operation 615.

The drying operation may be needed because by-products may be liquid or semi-liquid. In some example embodiments, some operations can be absent or two or three operations can be combined into one step.

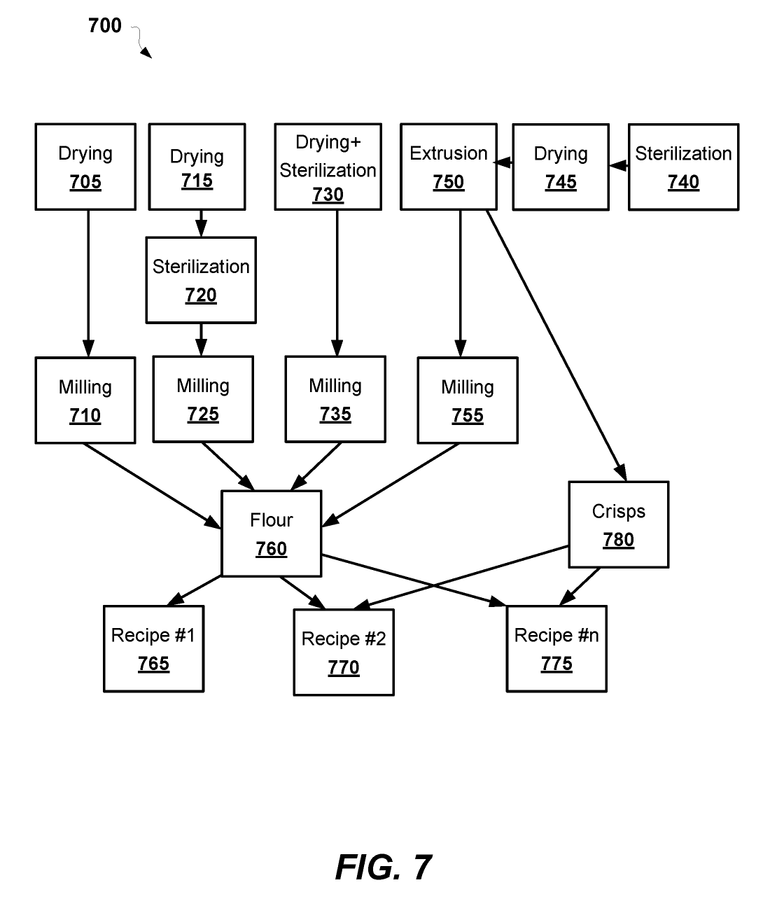

FIG. 7 is a block diagram 700 illustrating a plurality of pre-processing and post-processing operations of the method for upcycling solid food wastes and by-products into food-grade nutritional products. A portion of the raw plant-based material may be dried at operation 705 and milled at operation 710. Another portion of the raw plant-based material may be dried at operation 715, sterilized at operation 720, and milled at operation 725. Further portion of the raw plant-based material may be dried and sterilized at operation 730 and milled at operation 735. One more portion of the raw plant-based material may be sterilized at operation 740, dried at step 745, and processed by the extruder at operation 750. The food ingredient provided by the extruder may be milled at operation 755.

All raw plant-based material milled at operations 710, 735, and 735, and the food ingredient milled at operation 755 may be mixed into flour at operation 760. The flour obtained at operation 760 may be used to prepare nutritional products at operations 765, 770, and 775 according to various recipes.

In some example embodiments, the food ingredient provided by the extruder at operation 750 may be processed into crisps at operation 780. The crisps may be used to prepare nutritional products at operations 765, 770, and 775 according to various recipes. In an example embodiment, air classifier mill added at post-production stage can turn crisps into flour to be used in multiple applications.

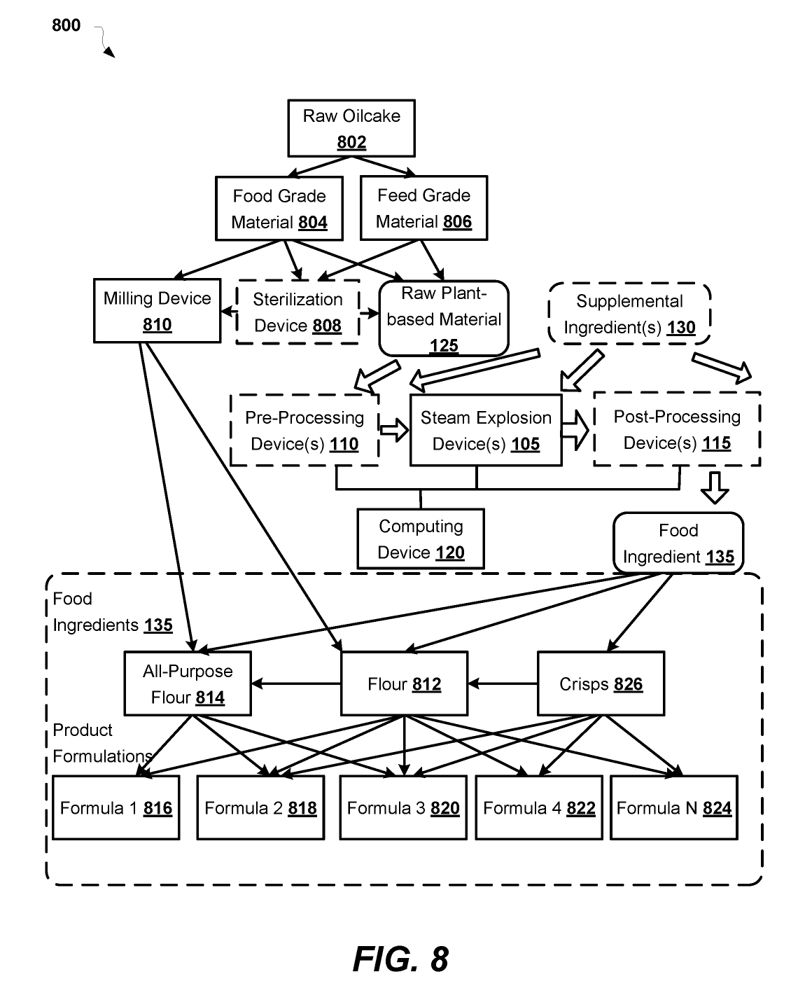

FIG. 8 illustrates an example system 800 for producing a high-protein nutritional ingredient according to certain example embodiments. As shown in FIG. 8, system 800 raw oilcake is received at step 805. The raw oilcake 802 can be of a food grade material 804 or a feed grade material 806. If it is of the food grade material 804, the raw oil cake 802 can be optionally sterilized at step 808 (e.g., by heating). The raw oilcake 802 is then processed by crushing or milling at step 810 to produce a processed oilcake, which is a food ingredient 135. The food ingredient 135 can be in the form of a powder or milled product and, therefore, it can be easily added to a flour 812 or an all-purpose flour 814 such as an all-purpose wheat flour or nut flour. The mix of all-purpose (nut) flour and the food ingredient is then used as an ingredient to manufacture a variety of products according to formulas 1, 2, 3, 4, . . . N such as pasta, bread, cookies, pancakes, soups, spreads, dips, ramen, brownies, and so forth, as shown by steps 816, 818, 820, 822, and 824.

Alternatively, the raw oilcake 802, whether it is of food grade or feed grade, can be processed to produce the food ingredient 135 involving steam flashing process discussed in more detail below. Specifically, as shown in FIG. 8, system 800 includes a steam explosion device 105 which may include an extruder, pelletizer, heating device, microwaving device, frying device, and the like. This disclosure is focused on the use of an extruder solely as an example and not a limitation. The steam explosion device 105 receives raw plant-based material 125 (e.g., one or more oilcakes as discussed herein) or pre-processed raw plant-based material. The raw plant-based material 125 can also include one or more optional supplemental ingredients 130. In some embodiments, there can be provided two or more steam explosion devices 105 connected in a series. The steam explosion device 105 may output a processed raw plant-based material (including any optional supplemental/additional ingredients), which is also referred to as a food ingredient 135.

An input of the steam explosion device 105 may be operatively and directly connected to one or more optional pre-processing devices 110. The pre-processing devices 110 can include, without limitation, one or more mixers, grinders, cutting devices, dispensing devices, moisturizing devices, supplying devices, transporting devices, dosing devices, and so forth. It should be understood that one or more pre-processing devices 110 perform pre-processing operations, such as moistening by mixing raw plant-based material 125 with water or other liquids. The one or more pre-processing devices 110 can also provide mixing of the raw plant-based material 125 with optional supplemental/additional ingredients 130. The one or more pre-processing devices 110 can also perform heating, cooling, compressing, decompressing, feeding, pressing, supplying, or any other similar operation against the raw plant-based material 125, including one or more optional supplemental ingredients 130.

An output of the steam explosion device 105 can be operatively and directly connected to one or more optional post-processing devices 115. The post-processing devices 115 receive the food ingredient from the steam explosion device 105 and perform one or more optional post-processing operations. Example post-processing operations include, without limitation, one or more of the following: mixing, grinding, cutting, milling, hot oil or hot air expanding, popping, puffing, drying, and coating. As shown in the FIG. 8, one or more optional supplemental ingredients 130 can be introduced (and mixed) at any production stage, i.e., at the pre-processing device 110, steam explosion device 105, or post-processing device 115. An output of the post-processing devices 115 is the food ingredient 135, which can be in the form of or be added to the form of all-purpose flour 814, nut of any other type of flour 812, or crisps 826. The flour 812, the all-purpose flour 814, or crisps 826 are then mixed with one or more supplemental ingredients.

As already discussed, the system 800 can further include additional components, such as a computing device 120 and one or more sensors for controlling the operation of any or all devices used in system 800. Computing device 120 can be configured to run software or a protocol to enable operation of system 800 at preferred parameters in order to make sure that the generation of the food ingredient 135 is within a predetermined or preferred regime. For example, sensors can measure a temperature and a conveying speed of the extruder, while the computing device 120 can adjust operation of any of pre-processing devices 110, steam explosion device 105, or post-processing devices 115 to make sure that the food ingredient 135 is of predetermined quality or has predetermined parameters (e.g., that it became sterile and palatable).

Example A: Bread/Tortilla

An example nutritional product in the form of bread or tortilla includes from about 1% to about 80% of a food ingredient (which includes a processed oilcake produced by a process involving steam flashing, crushing or milling of water-insoluble raw oilcake) and from about 99% to 50% of supplemental ingredients. The supplemental ingredients include:
1 package (¼ ounce) of active dry yeast;
2¼ cups of warm water (e.g., from about 110° to about 115°;
3 tablespoons of sugar (i.e., about 37.5 g);
1 tablespoon of salt (i.e., about 15 g);
2 tablespoons of canola oil (i.e., about 28 g);
All-purpose wheat flour (i.e., about 546 g) mixed with about 234 g of the food ingredient;
Optionally: water, sugar, salt, and species/food flavors/additives.

An approximate total cost of this nutritional product was only $0.6329; total calories were about 3127.32; dietary fiber was about 56,86 g; and protein was about 136,50 g. Comparing this to a comparable traditional recipe for bread, which includes only about 21,06 g of fiber and only 78,00 g of protein, the nutritional product (bread) created based on the methodologies disclosed herein yielded unexpectedly significantly higher amounts of protein and fiber. Furthermore, it is important to note that this example nutritional product is comparable to the traditional recipe for bread in costs and calories. An approximate total cost for the example nutritional product is about $0.6433 (total calories are about 3155.40), while the bread based on the traditional recipe costs about $0.6329 (total calories are about 3127.32).

Example B: Pancakes/Flapjacks

An example nutritional product in the form of pancakes or flapjacks includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include:
1 cup of all-purpose flour (i.e., any of all-purpose flour, bread flour, wheat flour, rye flour, spent grain flour, rice flour, spelt flour, barley flour, oat flour, amaranth flour, or nut flour);
½ cup of oilcake;
3½ teaspoons of baking powder;
1 teaspoon of salt;
1 tablespoon of white sugar;
1¼ cups of milk;
1 egg;
3 tablespoons of melted butter;
Optionally: water, sugar, salt, and species/food flavors/additives.

Example C: Brownies, Cookies, Pretzels

An example nutritional product in the form of brownie, cookies, or pretzels includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include:
½ cup of butter;
1 cup of white sugar;
2 eggs;
1 teaspoon of vanilla extract;
⅓ cup of unsweetened cocoa powder;
¼ cup of all-purpose flour (i.e., any of all-purpose flour, bread flour, wheat flour, rye flour, spent grain flour, rice flour, spelt flour, barley flour, oat flour, amaranth flour, or nut flour);
¼ cup of oilcake;
¼ teaspoon of salt;
¼ teaspoon of baking powder;
Optionally: water, sugar, salt, and species/food flavors/additives.

Example D: All-Purpose Baking Mix

An example nutritional product in the form of all-purpose baking mix includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include:
4 cups of all-purpose flour (i.e., any of all-purpose flour, bread flour, wheat flour, rye flour, spent grain flour, rice flour, spelt flour, barley flour, oat flour, amaranth flour, or nut flour);
2 cups of oilcake;
3 tablespoons of baking powder;
1 tablespoon of salt;
¾ cup of shortening (butter or other fat used for making pastry or bread);
Optionally: water, sugar, salt, and species/food flavors/additives.

Example E: Pasta/Ramen

An example nutritional product in the form of pasta or ramen includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include flour (e.g., all-purpose flour, wheat flour, rye flour, spent grain flour, rice flour, buckwheat flour, spelt flour, barley flour, oat flour, amaranth flour, or nut flour), sugar, salt, oil, and eggs.

Example F: Puree/Hummus

An example nutritional product in the form of puree or hummus includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include fruit puree, veggie puree, citric acid, sugar, salt, and oats.

Example G: Spread/Paste

An example nutritional product in the form of puree or hummus includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include protein powder, nuts, seeds, legumes, sugar, salt, and oil.

Example H: Protein Bars

An example nutritional product in the form of puree or hummus includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include flour (e.g., all-purpose flour, wheat flour, rye flour, spent grain flour, rice flour, buckwheat flour, spelt flour, barley flour, oat flour, amaranth flour, or nut flour), sugar, salt, oil, eggs, seeds, nuts, dried fruits, and crisps.

Example I: Soup

An example nutritional product in the form of puree or hummus includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include flour (e.g., all-purpose flour, wheat flour, rye flour, spent grain flour, rice flour, buckwheat flour, spelt flour, barley flour, oat flour, amaranth flour, or nut flour), sugar, salt, oil, eggs, veggies, protein powders, and starches.

Example J: Cereal

An example nutritional product in the form of puree or hummus includes from about 1% to about 50% of a food ingredient (which includes a processed oilcake produced by a process involving steam flashing, crushing or milling of water-insoluble raw oilcake) and from about 99% to 50% of supplemental ingredients. The supplemental ingredients include flour (e.g., all-purpose flour, wheat flour, rye flour, spent grain flour, rice flour, buckwheat flour, spelt flour, barley flour, oat flour, amaranth flour, or nut flour), sugar, salt, oil, eggs, milk, starches, and bran.

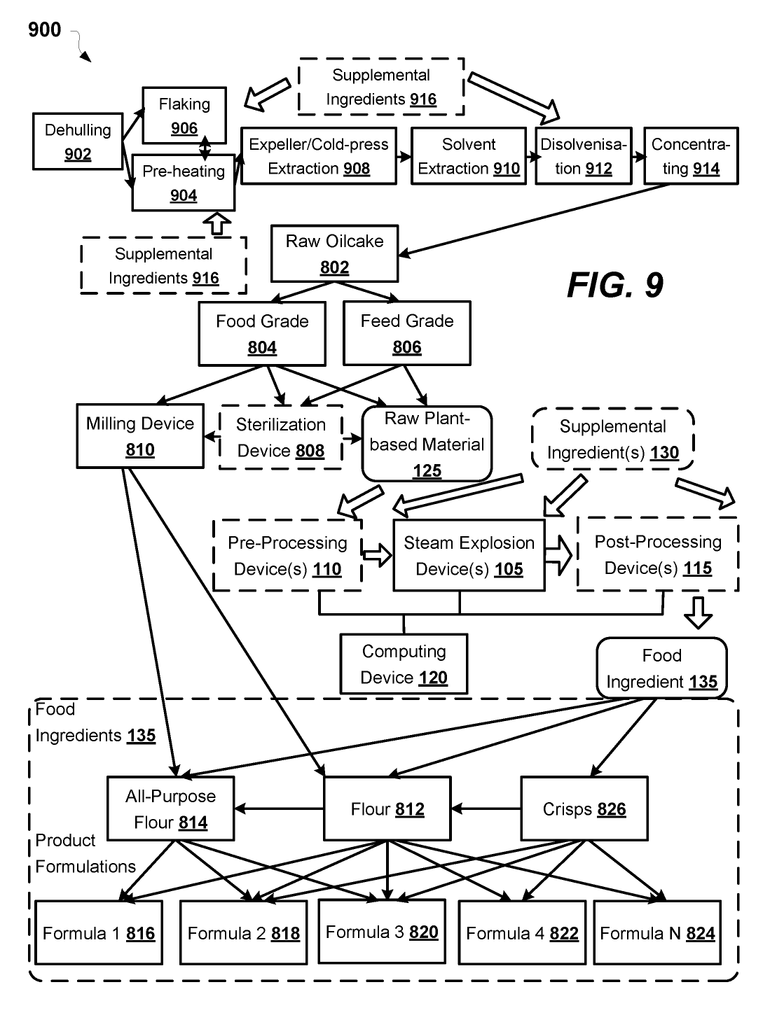

FIG. 9 illustrates an example system 900 for upcycling oilcake and related (derivative) products according to one example embodiment. As shown in FIG. 9, the system 900 includes a chain of instruments or devices to produce raw oil cake. These devices include a crushing mechanism, a dehulling mechanism, a flaking mechanism, a pre-heating mechanism, an expeller or cold-press extraction mechanism, a solvent extraction mechanism, a desolvenisation mechanism, a concentrating mechanism. There can be also provide containers for storage raw and processed materials, feeders, transportation devices, and so forth.

In general, the system of FIG. 9 receives oil seeds (e.g., sunflower seeds) and one or more optional and supplemental ingredients 916 such as antioxidants or acidity regulators. The optional crushing mechanism may cause cracking, crushing or cutting the oil seeds to produce crushed oil seeds. The crushed oil seeds can be supplied to the dehulling mechanism at step 902 where the crushed oil seeds are processed to produce dehulled crushed oil seeds. The dehulled crushed oil seeds can be then conditioned by pre-heating at step 904 to produce conditioned seed product.

Additionally, or as an alternative to the conditioning, the dehulled crushed oil seeds or the conditioned seed product can be provided to the flaking mechanism to produce flaked seeds at step 906. The flaked seeds can be further and optionally supplied to the expeller (cold-press extraction mechanism) at step 908, the solvent extraction mechanism at step 910, the desolvenisation mechanism at step 912, and the concentrating mechanism at step 914. At the output of the above mechanisms, raw oilcake is manufactured.

Importantly, during the process of upcycling the raw oilcake, there can be added antioxidants to prevent transformation of chlorogenic acid (CGA) into chlorogenic acid quinone (CGA-Q) during the dehulling, conditioning, or flaking operations. Optionally, the PPO can be deactivated by heating the conditioned seed product at a temperature selected in the range of 150-170° C. Alternatively, the flaked oil seeds can be conditioned by heating to produce the raw oilcake, where the heating is performed at a temperature selected in a range from 150-170° C. to inactivate PPO.

The raw oilcake 802 can be used for producing a high-protein nutritional ingredient as described with reference to FIG.8.

In some embodiments, the food ingredient 135 can be in the form of a protein concentrate powder or milled product and, therefore, it can be easily added to a flour such as an all-purpose wheat flour or nut flour. The mix of all-purpose (nut) flour and the food ingredient is then used as an ingredient to manufacture a variety of such as pasta, bread, cookies, pancakes, soups, spreads, dips, ramen, brownies, and so forth.

In other embodiments, the nutritional product 135 and one or more supplemental ingredients are mixed, cooked, heated, fried, backed, or otherwise processed to produce edible and complete products. These products can be in the form of a bread, tortilla, pancake, flapjack, brownie, cookie, pretzel, baking mix, pasta, ramen, puree, hummus, spread, dip, paste, protein bar, soup, snack, cereal, and so forth.

Furthermore, as discussed above, the nutritional product can be added to or mixed with one or more supplemental ingredients to produce the food product with reduced amount of green-color colorization ingredients. Below are provided various example nutritional products which can be manufactured based on the methodologies disclosed herein.

Example: Cookie Recipe

To produce a cookie, the following ingredients are taken:
100 grams of butter, room temperature;
2 eggs;
200 g of sugar;
168 g of wheat flour;
72 g flour from defatted sunflower seeds with neutralized CGA;
0.5 tsp. of soda;
0.5 tsp. of lemon juice; and
1 tsp. of cinnamon powder.

To make the flour from defatted sunflower seeds with neutralized CGA (protein=35%, hulls content=8%), 1% Ascorbic acid was added to the sunflower seeds before oil extraction and 0.5% citric acid added after oil extraction. The cookies manufactured using this method (recipe) demonstrated significant green color reduction.

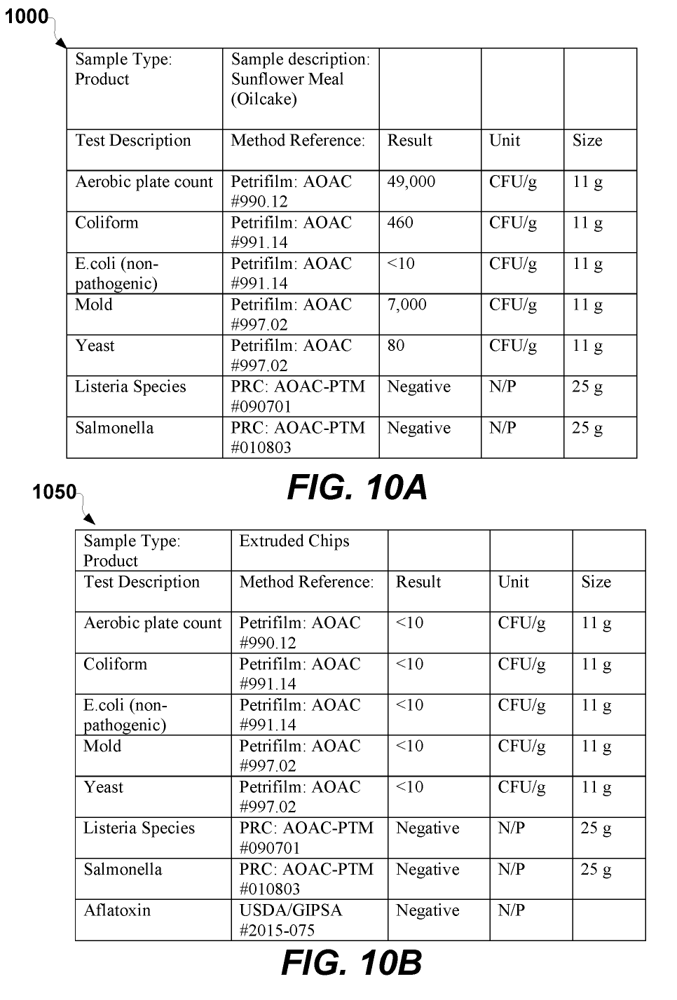

FIG. 10A shows results 1000 of analysis of an oilcake before processing by the method described herein. The oilcake in the form of sunflower meal included aerobic plate count in the amount of 49,000 Colony Forming Units per gram (CFU/g), coliform in the amount of 460 CFU/g, E. coli (non-pathogenic) in the amount of <10 CFU/g, mold in the amount of 7,000 CFU/g, yeast in the amount of 80 CFU/g, and had negative results for listeria species and salmonella.

FIG. 10B shows results 1050 of analysis of extruded chips recycled from the oilcake (analysis of which is illustrated on FIG. 10A) by the method described herein. The chips included aerobic plate count, coliform, E. coli (non-pathogenic), mold, and yeast in the amount of <10 CFU/g, and had negative results for listeria species, salmonella, and aflatoxin.

Thus, food-grade nutritional products, system for upcycling solid food wastes and by-products into food-grade nutritional products, and methods for upcycling solid food wastes and by-products into food-grade nutritional products have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A food-grade nutritional product comprising:
a food ingredient produced from a raw plant-based material, wherein the food ingredient is produced by a method comprising:
supplying the raw plant-based material;
continuously subjecting the raw plant-based material to steam flashing at predetermined temperature and predetermined pressure to:
sterilize the raw plant-based material;
destroy antinutrients present in the raw plant-based material;
cause a break up of larger cellular and subcellular units of the raw plant-based material into smaller cellular and subcellular units of the raw plant-based material to transform the raw plant-based material into the food ingredient; and
reduce water content in the food ingredient.

2. The food-grade nutritional product of claim 1, further comprising at least one supplemental ingredient, wherein the supplemental ingredient includes one or more of the following: carbohydrates, proteins, fats, vitamins, minerals, food agents, flavoring agents, preservatives, stabilizers, and colorants.

3. The food-grade nutritional product of claim 2, wherein a content of the food ingredient is from 1% to 99.9%, and wherein a content of the at least one supplemental ingredient is from 0.01% to 99%.

4. The food-grade nutritional product of claim 1, wherein the high-protein nutritional product has one of the following forms: a crisp form, a granulated form, a pelletized form, and a flour.

5. The food-grade nutritional product of claim 1, wherein the food-grade nutritional product includes one or more of the following: a nutritional substance ready for human consumption, an additive to a hybrid meat, and an additive to pet foods.

6. The food-grade nutritional product of claim 1, wherein the raw plant-based material includes one or more of the following: solid food wastes and by-products.

7. The food-grade nutritional product of claim 6, wherein the solid food wastes are selected from a group comprising: a sorted solid food waste, an unsorted solid food waste, a food grade solid food waste, a feed grade solid food waste, a plant-based solid food waste, a pure solid food waste, and a solid food waste mixed with one or more of the following: further ingredients, nutrients, and chemicals, wherein the by-products are selected from a group comprising: a raw oilcake, wet or dried distillers grains, a by-product of animal processing, a by-product of fish processing, an insect, a cricket, a worm, and bacteria.

8. A nutritional product for human consumption, the nutritional product comprising:
the nutritional product comprising: from about 1% to about 80% of a food ingredient, wherein the food ingredient includes an upcycled raw ingredient, wherein the upcycled raw ingredient is produced by a process involving steam flashing of raw oilcake or wet or dried distillers grains, crushing of raw oilcake or wet or dried distillers grains, or milling of raw oilcake or dried distillers grains; and from about 20% to about 99% of a supplemental ingredient, wherein the supplemental ingredient includes fat, carbohydrates, protein, minerals or vitamins.

9. The nutritional product of claim 8, wherein the food ingredient and the supplemental ingredient are processed into at least one of the following forms: bread and bakery products such as, doughnuts, pastries, cakes, pies and rusks, pizza crust, bagels, muffins, cookies, extruded products, snacks, biscuits, crackers, tortilla chips, flips, pretzels, breakfast products such as jams, marmalades, cocoa-based spreads, muesli, cereals, purees, spreads, desserts, candies, pancakes, waffles, energy or snack or meal replacement bars and powders, and protein foods, ready meals, soups, pasta, noodles, cooked grains, burger bun, sandwiches, grain-based mixed dishes, soups, cooked grains, mixed dishes, confectionery products such as chocolate products, ice cream, frozen dairy desserts, hybrid meat products, sausages, patties, sauces, condiments, dips, gravies, salad dressings, French fries, mashed potatoes and white potato mixtures, baby food, pet food, nutritional beverages.
